(19) United States
(12) Patent Application Publication
(10) Pub. No.: US 2026/0252758 A1
(43) Pub. Date: Aug. 27, 2026

(54) SPATIALLY PARTITIONED NETWORK GRAPH

(71) Applicant: Schneider Electric USA, Inc., Boston, MA (US)

(72) Inventor: James Wright, Westminster, CO (US)

(73) Assignee: Schneider Electric USA, Inc., Boston, MA (US)

(21) Appl. No.: 19/059,685

(22) Filed: Feb. 21, 2025

(51) Int. Cl. G06F 30/18; G06F 16/29; G06F 113/04

(52) U.S. Cl. CPC G06F 30/18; G06F 16/29; G06F 2113/04

(57) ABSTRACT

A method for constructing a model for a distribution network includes receiving network source data for a the distribution network. The method includes spatially partitioning data from the network source data into a plurality of grids, wherein each grid represents a physical space and includes a portion of the data from the network source data representing physical assets located in the physical space.

### BACKGROUND

### 1. Field

The present disclosure relates to geographic information systems, and more particularly to geographic information systems (GISs), digital energy systems, digital grid systems, and the like, for physical infrastructure such as electrical utility grids, gas utility grids, optic fiber or coaxial cable utility grids, water utility grids, wastewater utility grids, and the like.

### 2. Description of Related Art

Traditionally, physical infrastructure assets in a utility grid, such as an electrical utility grid, could be indexed in a database. In older structures or buildings, this could be a paper database, e.g., including technical drawings showing the interrelationships of assets. In digital age structures, the database could be digitally formatted and searchable.

The conventional techniques have been considered satisfactory for their intended purpose. However, there is an ever-present need for improved systems and methods for improved indexing, partitioning, and updating processes for keeping track of infrastructure such as in a utility grid. This disclosure provides a solution for this need.

### SUMMARY

A method for constructing a model for a distribution network includes receiving network source data for a the distribution network. The method includes spatially partitioning data from the network source data into a plurality of grids, wherein each grid represents a physical space and includes a portion of the data from the network source data representing physical assets located in the physical space.

Each grid can be fully atomic and can be indexed and reindexed without regard to surrounding areas of the data. The method can include cross-coordinating otherwise atomic spatially partitioned topological network indexes. For each grid of the plurality of grids, for any linear asset including relationships that leaves an extent of the physical space of the grid and thereby is not fully contained within the extent, cross-coordinating can include only indexing an (X, Y) coordinate of each outlying vertex representing a physical asset outside the grid but connected by the linear asset to a physical asset within the grid, and not fully indexing the outlying vertex within the grid itself. The method can include using an outlying vertex indexed with (X, Y) coordinates during tracing. For each grid of the plurality of grids, for any vertex representing a physical asset which resides within the grid, spatially partitioning the data from the network source data can include fully indexing the connections of the physical asset of the vertex within an index of the grid.

Spatially partitioning data from the network source data into a plurality of grids can include receiving source data representative of an extent of assets of a utilities network, subdividing the extent into the plurality of grids wherein the grids are non-intersecting with one another, and for each grid in the plurality of grids, querying the source data by the extent and indexing applicable network elements via special vertex coincidence and relationships. Each grid in the plurality of grids can have a set of upstream and downstream nodes which identify connections between utility assets spatially within the grid and utility assets spatially outside the grid. Each grid in the plurality of grids can be indexed individually. The method can include creating a spatial R-Tree of subsequent grid extents so a full extent of source assets from the network source data are indexed via spatial partitioning. Spatially partitioning data from the network source data spatially into a plurality of grids can include parallelizing so multiple grids of the plurality of gids are partitioned in parallel with one another in parallel processing. The method can include updating the source data by only updating data of coincident grids of the plurality of grids without updating data of other grids of the plurality of grids.

The method can operate with linear time complexity. After indexing any one or more grids of the plurality of grids, the method can include communicating topological tracing as a single larger topological network to one or more consuming applications. Once indexing of any individual or set of grids is complete, topological tracing can be achieved and understood as a single larger topological network by consuming applications. The distribution network can be an electric distribution network. The network source data can include Geographic Information System (GIS) data corresponding to a distribution network or a portion thereof from a GIS database.

A non-transitory machine-readable medium includes instructions which when executed by a machine cause the machine to execute a method such as disclosed herein. A computer system for a distribution grid includes a memory and one or more processors communicatively coupled to the memory. The memory stores processor-executable instructions thereon that, when executed by the one or more processors, cause the system to perform methods as disclosed herein.

These and other features of the systems and methods of the subject disclosure will become more readily apparent to those skilled in the art from the following detailed description of the disclosed embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an embodiment of a method in accordance with the present disclosure, showing spatial partitioning into a plurality of grids for a distribution network on a geographic map of the distribution network;

FIG. 2 is a schematic flow diagram of the method of FIG. 1, showing the spatial partitioning schematically;

FIG. 3 is a schematic view of the spatial partitioning of FIG. 2, showing an example of a grid of FIG. 1;

FIG. 4 is a schematic diagram of a portion of the method of FIG. 1, showing the spatial partitioning of FIG. 2 with additional detail; and

FIG. 5 is a schematic view of a computer system in accordance with the present disclosure, showing the machine readable instructions for performing methods as in FIG. 2.

### DETAILED DESCRIPTION

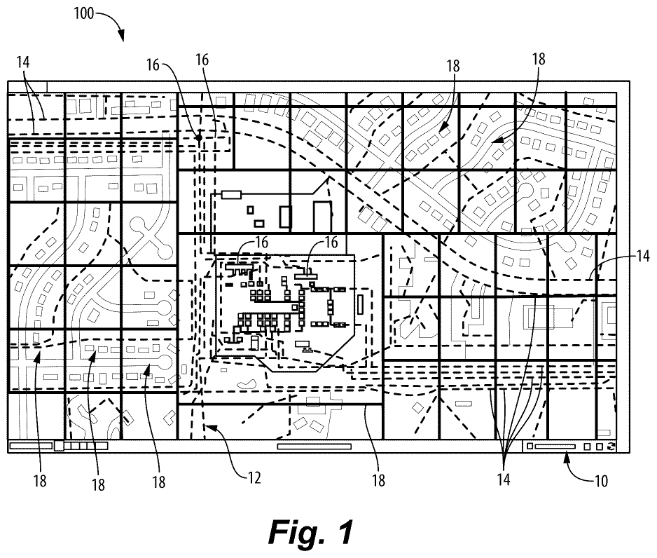

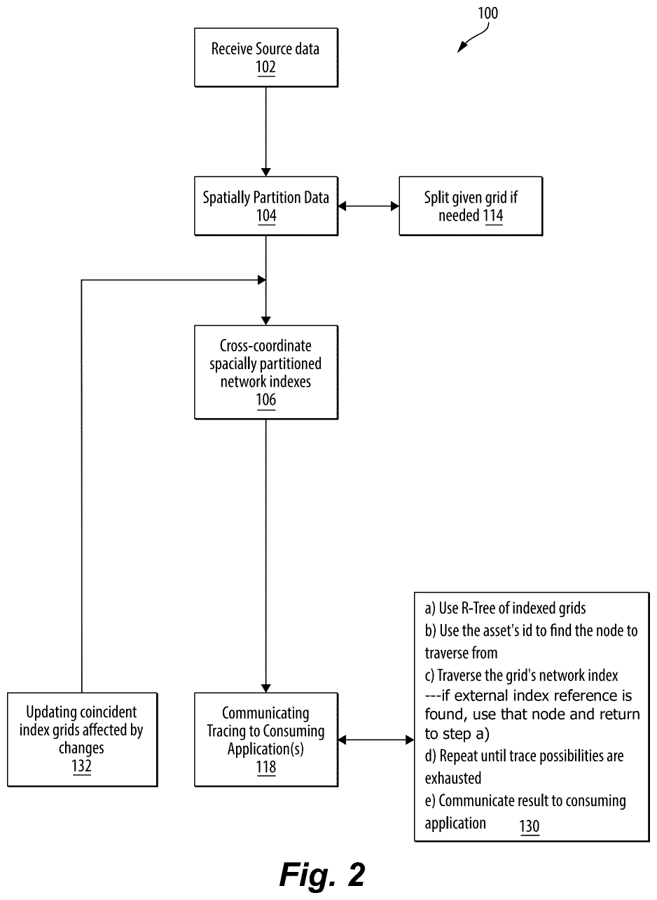

Reference will now be made to the drawings wherein like reference numerals identify similar structural features or aspects of the subject disclosure. For purposes of explanation and illustration, and not limitation, a partial view of an embodiment of a method in accordance with the disclosure is shown in FIG. 1 and is designated generally by reference character 100. Other embodiments of systems in accordance with the disclosure, or aspects thereof, are provided in FIGS. 2-5, as will be described. The systems and methods described herein can be used to spatially partition network graphs of distribution networks such as electrical grids, cable networks, optic fiber networks, telephone networks, water utilities, sewer utilities, gas utilities, or the like.

A method 100 for constructing a model for a distribution network 12 includes receiving a network source data for a the distribution network 12. As shown in FIG. 1, a distribution network such as a utility listed above, can be shown on a map 10. In FIG. 1 there is a geographic map 10 with dashed lines indicating utility lines 14 of the distribution network 12, and vertices 16 where the lines meet or end are where physical assets are located, e.g., transformers, junctions, generators, or the like (not all of the lines 14 and vertices 16 are labeled in FIG. 1 for sake of clarity). The method includes spatially partitioning data from the network source data into a plurality of grids 18, wherein each grid 18 represents a physical space and includes a portion of the data from the network source data representing physical assets located in the physical space. The spatial partitioning should result in non-intersecting, e.g., tessellated grids 18, although the grids 18 do not necessarily need to all be the same rectangular size, and there may be portions of the map where there are no lines or vertices that are not covered by any particular grid 18 (not all of the grids 18 are labeled in FIG. 1 for sake of clarity). In addition, while shown and descript herein with two-dimensional grids 18 for sake of clarity, those skilled in the art having had the benefit of this disclosure will readily appreciate that three-dimensional grids can also be used.

With reference now to FIG. 2, an overview of the method 100 is shown. The receipt of a network source data mentioned above is identified with box 102. The network source data can be an over all list of lines 14 and vertices 16 from the map 10 of FIG. 1 and associated data. For instance, if one of the vertices 16 represents a generator, the network source data can include data indicating the vertex is a generator and data describing the generator as needed. The network source data can include Geographic Information System (GIS) data corresponding to the distribution network 12 (labeled in FIG. 1) or a portion thereof from a GIS database.

In FIG. 2, the spatial partitioning is indicated with box 104. Spatial partitioning includes generating a Grid of grids 18 over the full data extent. Foreach grid 18, the method 100 includes querying the data spatially. Based on a configurable parameter, the method 100 ascertains if a given grids extent contains more than desired quantity of assets, and if so the method 100 splits the grid, as represented by box 114, otherwise the method can continue without splitting the grid 18. For each point asset and vertex 16 of a linear asset, the method 100 determines if is within extent of grid, or outside. The method 100 indexes all adjacencies within this grid's indexes, and only persists (X, Y) coordinate of a vertex 16 and its adjacencies to nodes outside this grid's index. This allows for later tracing to traverse between grids 18. Once all grids are indexed, the method uses a spatial index, such as an R-Tree, to ‘index’ the spatial (X, Y) extents of each grid for later use in tracing, as discussed below with reference to box 130. This allows the rapid traversal between grids leveraging the (X, Y) coordinates indexed in the previous step.

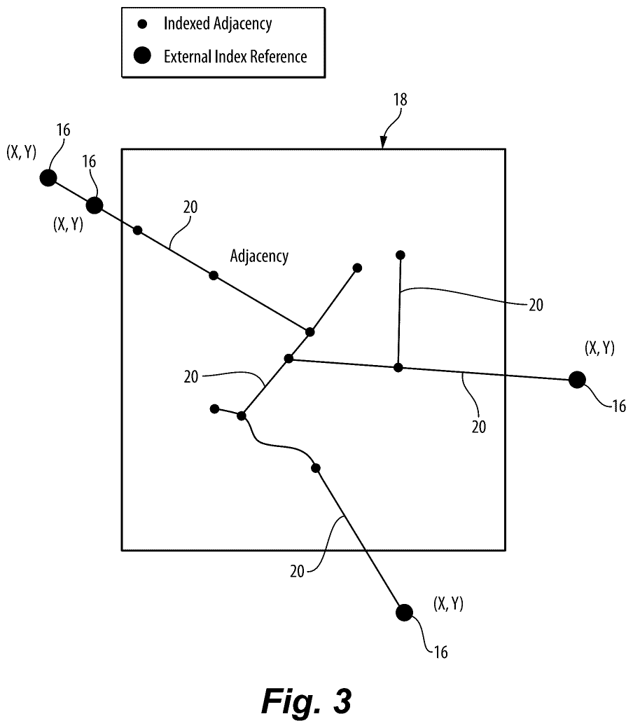

Each grid 18 (labeled in FIG. 1) is fully atomic and can be indexed and reindexed without regard to surrounding areas of the data. The method includes cross-coordinating otherwise atomic spatially partitioned topological network indexes, as represented by box 106. After indexing any one or more of the grids 18 (labeled in FIG. 1), the method 100 includes communicating topological tracing as a single larger topological network to one or more consuming applications, as represented by box 118. Once indexing of any individual or set of grids 18 is complete, topological tracing can be achieved and understood as a single larger topological network by consuming applications. The tracing of box 118 can include the operations represented in box 130, which include the following. Given a start asset or node's (X, Y) spatial coordinate, use an R-Tree of indexed grids 18 to ascertain the grid index to traverse. Once an applicable grid 18 is ascertained, use the asset's id (key into the index) to find the ‘node’ within the index to traverse from. Traverse the grid's network index, using what filters, etc., are defined by the trace. Should a node be reached referencing an (X, Y) coordinate (outside this grid's index) continue to step 1 using the node's (X, Y) coordinate and ID. Repeat until trace possibilities are exhausted. Communicate result to consuming application. Indexing with (X, Y) coordinates is further described below with reference to FIG. 3.

With continued reference to FIG. 2, if there are changes in the distribution network 12 (labeled in FIG. 1) such as upgrades, damage, decommissioning, or additions of physical hardware, the method 100 includes updating the changes relative to the source data, wherein the index can be re-indexed by only updating coincident index grids affected by the those changes, as represented by box 132. This ability to update an index by only updating indexes of coincident grids 18 reduces overall reindexing complexity and cost compared to traditional methods. The traditional methods have no easy to way to denote granular index boundaries resulting in complex and inefficient locking mechanisms needed to ensure index integrity. Systems and methods disclosed herein can do the same without locking entire large sections of the index, reducing the time needed to make changes to be practically instant and allowing for simplified performant parallelization of updates in different spatial regions of the data. This also facilitates modeling changes to the distribution network (labeled in FIG. 1), since the modeled changes only need to be updated for coincident grids 18 to implement or test the modeled changes.

With reference now to FIG. 3, there is a schematic example of a grid 18. Each grid 18 in the plurality of grids 18 has a set of upstream and downstream nodes, e.g., which can be empty if applicable, which identify connections between utility assets spatially within the grid 18 and utility assets spatially outside the grid 18. For each grid 18, for any linear asset 20, including relationships, which represent a linear connection such as a power line, data line, pipeline, or the like, that leaves an extent of the physical space of the grid 18 and thereby is not fully contained within the extent, cross-coordinating includes only indexing an (X, Y) coordinate and its id of each outlying vertex 16 representing a physical asset outside the grid 18 but connected by the linear asset 20 to a physical asset (or vertex 16) within the grid 18. This means not fully indexing the outlying vertex 16 within the grid 18 itself, i.e. only including the (X, Y) value and its id for the outlying vertex 16 within the data structure representing grid 18. In FIG. 3, the outlying vertices 16 are indicated with large points and the vertices fully contained within the grid 18 are indicated with small points. For each grid 18 of the plurality of grids 18 of FIG. 1, for any vertex 16 or point feature representing a physical asset which resides within the grid 18, spatially partitioning the data from the network source data 104 (labeled in FIG. 2) includes fully indexing the connections of the physical asset of the vertex 16 within an index of the grid 18. Those skilled in the art will readily appreciate that FIG. 3 is not intended to be to scale. Each grid 18 can be any rectangular size but generally they are large enough to contain thousands of features, not a handful as illustrated for sake of simplicity and clarity in the drawings.

Additionally, the external nodes may not necessarily intersect with an adjacent grid 18, but could be many grids 18 away.

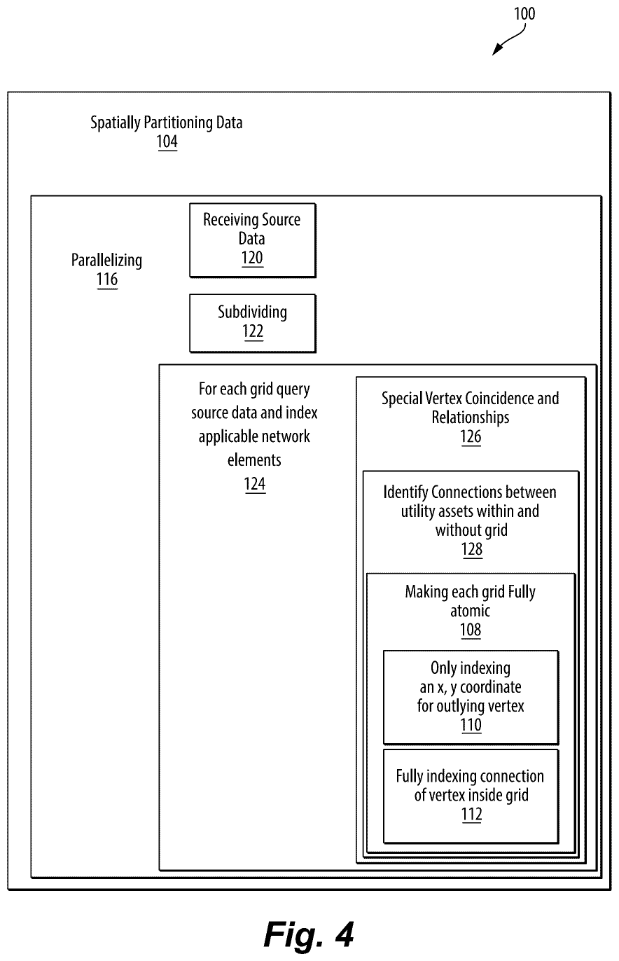

Referring now to FIG. 4, spatially partitioning data 104 of FIG. 2 is shown and described further. Spatially partitioning data 104 from the network source data into a plurality of grids includes receiving source data representative of an extent of assets of a utilities network (as represented by box 120), subdividing, e.g., tessellating the extent into the plurality of grids wherein the grids are non-intersecting with one another and can be of varying sizes (as represented by box 122), and for each grid in the plurality of grids, querying the source data by the extent and indexing applicable network elements, as represented by box, 124. The applicable network elements can include, e.g., physical lines connecting assets in one grid 18 to those in another grid 18, via special vertex coincidence and, e.g. SQL relational, relationships (as represented by box 126).

Finding the special coincidence and relationships 126 can include identifying connections between utility assets within and without the grid (as represented by box 128 and described above with reference to FIG. 3), which can include making each grid fully atomic (as represented by box 108), which can itself include only indexing an (X, Y) coordinate for each outlying vertex and not fully indexing such assets within the data of the given grid 18 (as represented by box 110 and as described above with reference to FIG. 3) and fully indexing the connections of the vertices 16 inside each grid 18 (as represented by box 112 and as described above with reference to FIG. 3).

With continued reference to FIG. 4, parallel processing can be used, e.g., by parallelizing so multiple grids 18 (labeled in FIG. 1) are partitioned in parallel with one another in parallel processing. So even though each grid 18 in the plurality of grids 18 of FIG. 1 is indexed individually, receiving source data 120, subdividing 122, and querying source data and indexing applicable network elements 124 can be performed in parallel for multiple grids 18 (labeled in FIG. 1).

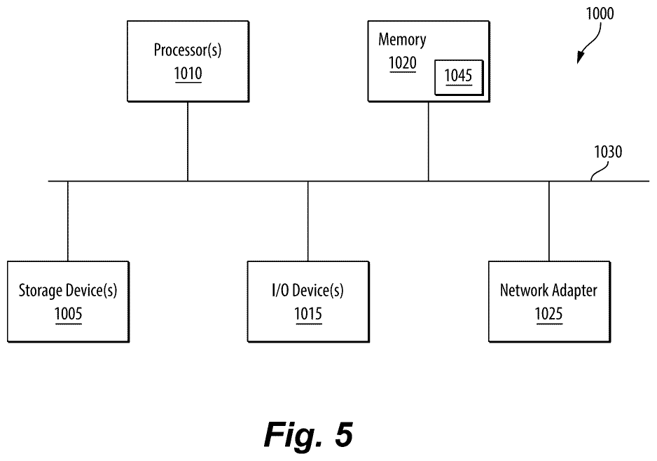

With reference now to FIG. 5, a computer system 1000 for a distribution grid is shown. The system 1000 includes a memory 1020 and one or more processors 1010 communicatively coupled to the memory 1020, e.g. by way of the interconnect 1030. The memory stores machine-readable, e.g., processor-executable, instructions 1045 thereon that, when executed by the one or more processors 1010, cause the system 1000 to perform methods as disclosed herein, e.g. starting from receiving the network source data as indicated by the box 102 in FIG. 2. The interconnect 1030 also connects a storage device 1005, e.g. a non-transitory machine readable medium where the machine readable instructions 1045 can be stored when not loaded in the memory 1020, and I/O Devices 1015 and network adapter 1035, e.g., for receiving the network source data from an external source, and for communicating tracing to consuming applications, as indicated in FIG. 2, box 118. Similarly, the I/O devices 1015 can accept user queries and output results of queries, e.g., on a display or printout, e.g., for when users model a change in a distribution network as explained above.

Systems and methods as disclosed herein provide potential benefits over the traditional techniques including the following. By providing spatially partitioned indexing and atomicity of each index grid, large datasets can be easily indexed, even partially so by only partitioning targeted extents. The atomicity of grid indexing processes disclosed herein allow for full index parallelization over large extents. Additionally, the indexing process can be fully parallelized. Once indexing of any individual or set of grids is complete, topological tracing can be achieved and understood as a single larger topological network by consuming applications. The method can include operating with linear time complexity, e.g., wherein the runtime increases in direct proportion to the size of its input. As the number of assets and size of the region increases, the time to index as disclosed herein can increases linearly. This allows for an algorithm to scale.

This disclosure provides for a simplified index update process due to granular index structure, and simple visualization of index progress and extent via (grid completion status). With systems and methods as disclosed herein, the index can be stored in contiguous blocks on a disk and/or in memory. Systems and methods as disclosed herein can increases performance as relevant nodes (with close spatial proximity) are loaded/unloaded efficiently together, and can provide easy distribution of partial extent of an index to offline clients by only distributing the grids necessary by any particular user. Systems and methods as disclosed herein provide simplified versioning of the index whereby any edits in a version simply require the updating of a copy of any applicable grid indexed extents.

FIG. 5 is a block diagram of an exemplary apparatus that can perform various operations, and store various information generated and/or used by such operations in some embodiments of the disclosed technology. The apparatus can represent any computer described herein. The computer 1000 is intended to illustrate a hardware device on which any of the entities, components or methods depicted in the examples of FIGS. 1-4 (and any other components described in this specification) can be implemented, such as a server, client device, storage devices, databases (e.g., GIS databases), and/or the like. The interconnect 1030 is shown in FIG. 5 as an abstraction that represents any one or more separate physical buses, point to point connections, or both connected by appropriate bridges, adapters, or controllers. The interconnect 1030, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 1010 is/are the central processing unit (CPU) of the computer 1000 and, thus, control the overall operation of the computer 1000. In some embodiments, the processor(s) 1010 accomplish this by executing software or firmware stored in memory 1020. The processor(s) 1010 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 1020 is or includes the main memory of the computer 1000. The memory 1020 represents any form of random access memory (RAM), read-only memory (ROM), flash memory, or the like, or a combination of such devices. In use, the memory 1020 may store a code. In some embodiments, the code includes a general programming module configured to recognize the general-purpose program received via the computer bus interface, and prepare the general-purpose program for execution at the processor. In another embodiment, the general programming module may be implemented using hardware circuitry such as ASICs, PLDs, or field-programmable gate arrays (FPGAs).

Also connected to the processor(s) 1010 through the interconnect 1030 are a network adapter 1025, a storage device(s) 1005 and I/O device(s) 1015. The network adapter 1025 provides the computer 1000 with the ability to communicate with remote devices, over a network and may be, for example, an Ethernet adapter or Fibre Channel adapter, or over a wireless network connection. The network adapter 1025 may also provide the computer 1000 with the ability to communicate with other computers within a cluster. In some embodiments, the computer 1000 may use more than one network adapter to deal with the communications within and outside of the cluster separately.

The I/O device(s) 1015 can include, for example, a keyboard, a mouse or other pointing device, disk drives, printers, a scanner, and other input and/or output devices, including a display device. The display device can include, for example, a cathode ray tube (CRT), liquid crystal display (LCD), or some other applicable known or convenient display device.

The code stored in memory 1020 can be implemented as software and/or firmware to program the processor(s) 1010 to carry out actions described above. In certain embodiments, such software or firmware may be initially provided to the computer 1000 by downloading it from a remote system through the computer 1000 (e.g., via network adapter 1025) .

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICS, PLDs, FPGAs, etc.

Software or firmware for use in implementing the technology introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine.

A machine can also be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

A machine-accessible storage medium or a storage device(s) 1005 includes, for example, recordable/non-recordable media (e.g., ROM; RAM; magnetic disk storage media; optical storage media; flash memory devices; etc.), etc., or any combination thereof. The storage medium typically may be non-transitory or include a non-transitory device. In this context, a non-transitory storage medium may include a device that is tangible, meaning that the device has a concrete physical form, although the device may change its physical state. Thus, for example, non-transitory refers to a device remaining tangible despite this change in state.

The term “logic”, as used herein, can include, for example, programmable circuitry programmed with specific software and/or firmware, special-purpose hardwired circuitry, or a combination thereof.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

The disclosed technology can also be adapted to other aspects of a utility distribution system such as the transmission/sub-transmission networks or the like.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

The methods and systems of the present disclosure, as described above and shown in the drawings, provide for spatially partitioning network graphs of distribution networks such as electrical grids, cable networks, optic fiber networks, telephone networks, water utilities, sewer utilities, gas utilities, or the like. While the apparatus and methods of the subject disclosure have been shown and described with reference to certain embodiments, those skilled in the art will readily appreciate that changes and/or modifications may be made thereto without departing from the scope of the subject disclosure.

What is claimed is:

1. A method for constructing a model for a distribution network comprising:
receiving network source data for a the distribution network; and
spatially partitioning data from the network source data into a plurality of grids, wherein each grid represents a physical space and includes a portion of the data from the network source data representing physical assets located in the physical space.

2. The method as recited in claim 1, wherein each grid is fully atomic and can be indexed and reindexed without regard to surrounding areas of the data.

3. The method as recited in claim 2, further comprising cross-coordinating otherwise atomic spatially partitioned topological network indexes.

4. The method as recited in claim 3, wherein for each grid of the plurality of grids, for any linear asset including relationships that leaves an extent of the physical space of the grid and thereby is not fully contained within the extent, cross-coordinating includes only indexing an (X, Y) coordinate of each outlying vertex representing a physical asset outside the grid but connected by the linear asset to a physical asset within the grid, and not fully indexing the outlying vertex within the grid itself.

5. The method as recited in claim 4, further comprising using an outlying vertex indexed with (X, Y) coordinates during tracing.

6. The method as recited in claim 5, wherein for each grid of the plurality of grids, for any vertex representing a physical asset which resides within the grid, spatially partitioning the data from the network source data includes fully indexing connections of the physical asset of the vertex within an index of the grid.

7. The method as recited in claim 1, wherein receiving network source data and spatially partitioning are performed with linear time complexity.

8. The method as recited in claim 1, wherein spatially partitioning data from the network source data spatially into a plurality of grids includes parallelizing so multiple grids of the plurality of gids are partitioned in parallel with one another in parallel processing.

9. The method as recited in claim 1, wherein the data is source data and further comprising:
updating the source data by only updating data of coincident grids of the plurality of grids without updating data of other grids of the plurality of grids.

10. The method as recited in claim 1, further comprising:
after indexing any one or more grids of the plurality of grids, communicating topological tracing as a single larger topological network to one or more consuming applications.

11. The method as recited claim 1, wherein spatially partitioning data from the network source data into a plurality of grids includes:
receiving source data representative of an extent of assets of a utilities network;
subdividing the extent into the plurality of grids wherein the grids are non-intersecting with one another; and
for each grid in the plurality of grids, querying the source data by the extent and indexing applicable network elements via special vertex coincidence and relationships.

12. The method as recited in claim 11, wherein each grid in the plurality of grids has a set of upstream and downstream nodes which identify connections between utility assets spatially within the grid and utility assets spatially outside the grid.

13. The method as recited in claim 1, wherein each grid in the plurality of grids is indexed individually, and further comprising:
creating a spatial R-Tree of subsequent grid extents so a full extent of source assets from the network source data are indexed via spatial partitioning.

14. The method as recited in claim 1, wherein the distribution network is an electric distribution network.

15. The method as recited in claim 1, wherein the network source data includes Geographic Information System (GIS) data corresponding to a distribution network or a portion thereof from a GIS database.

16. A non-transitory machine-readable medium comprising instructions which when executed by a machine cause the machine to execute a method comprising:
receiving network source data for a the distribution network; and
spatially partitioning data from the network source data into a plurality of grids, wherein each grid represents a physical space and includes a portion of the data from the network source data representing physical assets located in the physical space.

17. The non-transitory machine-readable medium as recited in claim 16, wherein each grid is fully atomic and can be indexed and reindexed without regard to surrounding areas of the data.

18. A computer system for a distribution grid comprising:
a memory; and
one or more processors communicatively coupled to the memory, wherein the memory stores processor-executable instructions thereon that, when executed by the one or more processors, cause the system to:
receive network source data for a the distribution network; and
spatially partition data from the network source data into a plurality of grids, wherein each grid represents a physical space and includes a portion of the data from the network source data representing physical assets located in the physical space.

19. The computer system as recited in claim 18, wherein each grid is fully atomic and can be indexed and reindexed without regard to surrounding areas of the data.

20. The computer system as recite in claim 19, wherein the processor-executable instructions, when executed by the one or more processors, cause the system to cross-coordinate otherwise atomic spatially partitioned topological network indexes.
